(19) United States
(12) Patent Application Publication
(10) Pub. No.: US 2011/0264463 A1
(43) Pub. Date: Oct. 27, 2011

(54) ACTIVITY NOTIFICATION SYSTEM AND METHOD

(75) Inventors: WILLIAM R. KINCAID, Gray, TN (US); Michael D. Combs, Bluff City, TN (US); Robert E. Goepel, Jonesborough, TN (US); Jason T. Goepel, Johnson City, TN (US)

(73) Assignee: AUTOMATED MEDICAL TECHNOLOGIES, LLC, Johnson City, TN (US)

(21) Appl. No.: 12/764,328

(22) Filed: Apr. 21, 2010

(51) Int. Cl. G06Q 50/00; G06F 3/048; G06F 15/16; G06Q 10/00

(52) U.S. Cl. 705/3; 705/2; 715/823; 709/203

(57) ABSTRACT

The activity notification process includes a first step of selecting an activity center on a home screen of a home station. The home screen of the home station has a plurality of selectable activity center choices, the selection thereof generating a plurality of selectable patient location options. The next step includes selecting one of the location options to send a message to an activity station of the activity center, the home station touch screen returning to its home screen with the activity center being predominantly highlighted thereon. The activity station generates an alert window providing directions to a location. The predominately highlighted activity center on the home station touch screen is deselected, only when the message has been answered, thereby returning the home screen thereon to a state that does not show the predominant highlights, the deselection providing verification that the message has been answered. The activity center may be disabled until the required activity is completed. The activity notification system is particularly adapted for use in a physician or dental office.

### BACKGROUND OF THE INVENTION

1. Field of the Invention

The present invention relates generally to activity notification systems, and more particularly to an activity notification system for facilities having a plurality of locations and activity centers.

2. Description of the Related Art

In a medical office setting, patient flow management is dedicated to achieving excellence in the patient experience through enhanced service, delivery and quality care. Patient flow issues are often the root cause of long wait times, extra and unnecessary occupation of beds, and lost revenue opportunities for hospitals, or the ability to serve more patients. Past experience shows that effective management of healthcare delays can produce dramatic improvements in medical outcomes, patient satisfaction, and access to service, while also reducing the cost of healthcare.

When asked to rank the challenges facilities currently face in coordinating the patient care process and the logistics associated with a patient's stay, healthcare executives list capacity problems, discharge and physicians as the three greatest challenges. Nearly all surveyed report some patient flow issues, with “poor communication” listed most frequently as the cause. It is clear that patient flow and efficiency plays a major role in patient satisfaction. One of the National Performance Measures when looking at quality of care is the assessment of patient satisfaction. When patients are seen in a timely manner they feel that they have been handled with care, they report back in a positive way, regardless of the results of their test or procedure.

There are numerous patents/patent applications that have involved medical office task management. For example, U.S. Pat. Publicn. No. 20090048868, entitled “Medication Related Task Notification System,” (Portnoy) discloses a task management system for informing a clinician of medication administration related tasks to be performed. The '868 system includes a repository of information. The repository of information associates data identifying multiple different medications with corresponding multiple post-administration alert messages. An individual alert message notifies a clinician of a particular post-administration task to be performed concerning a particular medication following administration of the particular medication to a patient. An input processor receives data indicating the particular medication has been administered to the patient. A workflow processor, in response to received data indicating the particular medication has been administered to the patient, uses the repository for identifying a post-administration task associated with the particular medication and automatically adds data indicating the post-administration task to be performed to a task list of a clinician. A reproduction device presents the post-administration task and task list of the clinician for viewing by a user.

U.S. Pat. Publicn. No. 20080082366, entitled “Automated Medical Treatment Order Processing System,” (Miller) discloses a system that employs a workflow engine and rules engine to automatically create, activate, discontinue, or perform other clinical orders functions without requiring a clinical user's interaction to initiate the orders. This facilitates advanced clinical workflow order automation, allowing to implement treatment protocols as automated system processes that improve clinical system processes efficiencies and the quality of patient care.

U.S. Pat. Publicn. No. 20090112614, entitled “Electronic System and Method For Health Management,” (Guimaraes) discloses an electronic healthcare management system that handles relevant aspects of providing healthcare services. The system integrates workflow principles to interconnect the different elements and persons involved in the process. The system uses personal computers with touch screen monitors and personal mobile devices which communicate via radio communication technologies throughout the healthcare facilities. Facility management, clinical practice, administrative activities and management tools are integrated into a single system.

U.S. Pat. Publicn. No. 20090043634, entitled “Worker Adaptive Task Management and Workflow System,” (Tisdale) discloses a system that provides a daily workflow list that is tailored according to nurse tenure, experience, specialty, licensure and education, for example. An adaptive healthcare workflow and task management system includes a repository of first information indicating clinician tasks and related subtasks for performance by a clinician in providing a particular care service to a patient. The system includes a repository of second information indicating experience and qualifications of multiple different clinicians. A rules processor, in response to a particular clinician identifier and data identifying a clinician task to be performed by the particular clinician in providing a particular care service to a patient, employs the first and second information in adaptively determining a subtask related to the clinician task to be indicated to be performed by the particular clinician based on experience and qualifications of the particular clinician. An output processor provides data for reproduction and presentation to the particular clinician indicating the subtask related to the clinician task to be indicated to be performed by the particular clinician.

U.S. Pat. Publicn. No. 20080294490, entitled “Networking Platform For Facilitating Interactions And Sharing Of Caretaking Responsibilities Between Family Members,” (Nuhaan) discloses systems and methods of a networking platform for facilitating interactions and sharing of caretaking responsibilities between family members. In one aspect, embodiments of that disclosure include a method, which may be implemented on a system, of managing a set of calendar events of the care receiver, the set of calendar events of the care receiver to be submitted by one or more of the care receiver and a caregiver. One embodiment can include, generating a reminder associated with an upcoming occurrence of a calendar event of the set of calendar events at a predetermined amount of time prior to the upcoming occurrence, the reminder to be provided to one or more caregivers, updating a status of one or more of the set of calendar events based on an update provided by one or more of the care receiver the caregiver, identifying the schedules of the one or more care givers, and/or identifying at least one responsible caregiver to manage a calendar event of the care receiver by comparing the schedules of the one or more care givers with the set of calendar events.

U.S. Pat. Publicn. No. 20080262870, entitled “Computerized Treatment Order and Associated Alert Processing System,” (Jones) discloses a system that enables users to identify alert checking performed, identify treatment orders and allergies associated with alerts, link medications and allergies with alert descriptions, and preview pending results of various alert resolution actions. A computerized treatment order and associated alert processing system employs a repository including information identifying candidate treatments for order and associated corresponding related order parameters. A user interface processor uses information from the repository for providing data representing an alert preview single display image in response to user selection of candidate treatments for order. The single display image identifies multiple candidate treatment orders including multiple related order parameters as well as multiple alert messages indicating potential adverse health consequences to a particular patient from administering the multiple candidate treatments to the particular patient. The single display image also associates individual alert messages with candidate treatment orders enabling a user to identify individual alert messages associated with an individual treatment order of the multiple candidate treatment orders.

U.S. Pat. Publicn. No. 20090313046, entitled “Healthcare Communication and Workflow Management System and Method,” (Badgett) discloses a communication and workflow management system and method for integrating a range of health care organization workflow management functions, generated by automated systems, manual and automated events associated with patients and staff interactions, through input-output devices such that requests and dispatch requests can be handled locally or over a widely distributed network, and can be tracked and escalated as required. The invention features a rules engine and database that identifies and defines resources, patients, tasks, and task handling. The invention uses extensive logic for the assignment of tasks and communication with resources that can execute tasks, tracking, completion of task, and escalation of tasks. The communication system can be integrated with staff and equipment tracking for automated closure of tasks.

Generally, the above-described patent publication references involve the use of quite complicated electronic medical record systems which do not provide verification that a task has indeed been performed.

Non-patent publications in this field are also generally directed to complicated electronic medical record systems, such as that discussed in: 1) Touchscreen clinical workstations at point of care: a paradigm shift in electronic medical record design for developing countries, McKay, M.V.1; Douglas, G.P.1 Source: 5th IET International Seminar on Appropriate Healthcare Technologies for Developing Countries—AHT 2008, 8 pp., 2008; and, 2) Qualitative evaluation of an electronic prescribing and administration system, The School of Pharmacy, London, UK, London School of Economics and Political Science, London, UK Accepted 30 Mar. 2007.

The article entitled “Is a touch screen for you?”, Technology Consult, Medical Economics; Feb. 3, 2006, by: Robert Lowes; Medical Economics, pg. 24, is directed to the use of a touch screen; however, as with the above-mentioned publications it is directed for use in the navigation through an electronic medical record system.

In the past, simple relatively simple medical activity alerting systems have involved mechanical systems using light bulbs. Such alert systems include, for example, that manufactured by Comlite System, Atlanta, Ga. (The system is described in, for example, COMLITE SYSTEMS, LCS4000/LAS4000 Installation & Operation Guide, ©2006 Comlite Systems.) However, such systems are limited in their functionality and ability to adapt to changes in the environment, such as the addition of new wings, new functions, etc. in medical offices.

As will be disclosed below, the present invention serves to fundamentally replace the mechanical lighting system so often seen at most doctors' offices and hospitals. It provides a simplified, easy to implement approach for providing efficient activity notification.

### SUMMARY OF THE INVENTION

In one broad aspect, the present invention is embodied as a medical activity notification process. This medical activity notification process includes a first step of selecting an activity center on a home screen of a home station. The home screen of the home station has a plurality of selectable activity center choices, the selection thereof generating a plurality of selectable patient location options. The next step includes selecting one of the location options to send a message to an activity station of the activity center, the home station touch screen returning to its home screen with the activity center being predominantly highlighted thereon. The activity station generates an alert window providing directions to a location. The predominately highlighted activity center on the home station touch screen is deselected, only when the message has been answered, thereby returning the home screen thereon to a state that does not show the predominant highlights, the deselection providing verification that the message has been answered.

In a preferred embodiment, the selected activity station of the activity center is at least partially disabled when one of said location options is selected. In one extreme the activity center is completely disabled until the required activity is completed. In another embodiment, some type of partial disablement, such as a warning is provided. The object is to provide the person in that activity center with the incentive to respond. For example, the screen may be locked immediately or within a selected time. Use of a preselected time delay allows the person in the activity center with the ability to complete a short task at his/her computer screen before being compelled to answer the notification call. Partially disabling may involve use of various warnings of the impending lock. These may include, for example, an hourglass, time lapse indicator, screen dimming, etc.

The present invention allows physicians to direct staff to their needs via a touchscreen monitor connected to staff workstations that replace the lighting switches common to a mechanical lighting system. The system then goes multiple steps further, initiating action to be taken by staff so that the physician and patients are not left waiting. The system was designed with simplicity in mind so it allows easy reset and visual confirmation that workflow tasks have been carried out. In addition, the system also can utilize audible notifications that will signal and cease with the respective actions of initiating and responding to (i.e. clearing) a task. The present invention prompts response and workflow, along with minimization of physician to staff involvement.

In an alternate embodiment, the patient location is selected first, and then the activity center is chosen.

Although particularly adapted for use in a physician or dental office, the present invention can be used for other offices or facilities requiring notification and direction between home stations, activity centers, and other locations (e.g., locations).

### BRIEF DESCRIPTION OF THE DRAWINGS

FIG. 1 is a block diagram of a first embodiment of the activity notification system, as implemented in a medical office environment.

FIGS. 2A-2H illustrate the steps in the process implemented by the system of FIG. 1.

FIG. 3 illustrates another embodiment of the activity notification system, with a plurality of home stations.

FIG. 4 is a system diagram illustrating the software implementation of the present invention.

The same elements or parts throughout the figures of the drawings are designated by the same reference characters, while equivalent elements bear a prime designation.

### DETAILED DESCRIPTION OF THE INVENTION

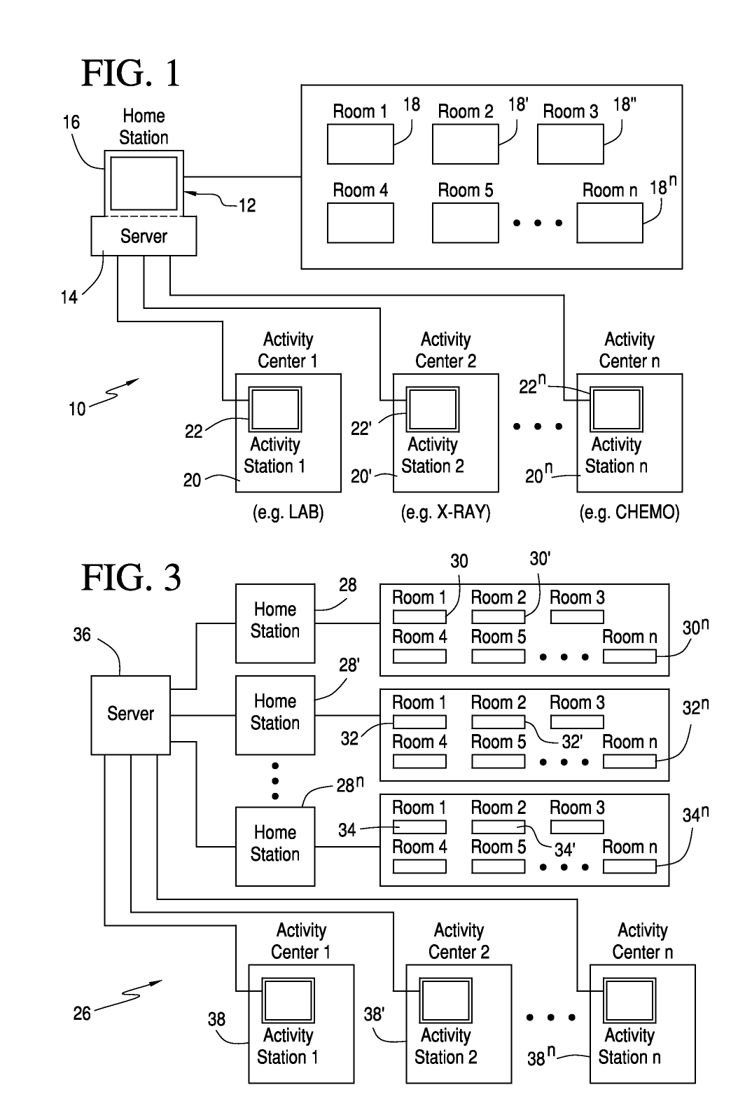

Referring now to the drawings and the characters of reference marked thereon, FIG. 1 illustrates a first embodiment the office activity system of the present invention, as implemented for a medical office, the system being designated generally as 10. The home station, designated generally as 12, includes a processing system 14 and a display 16 operatively connected to the processing system 14. The display 16 generates a home screen having a plurality of selectable activity center choices, the selection thereof generating a plurality of selectable location options. The selectable location choices are typically patient rooms, i.e. designated 18, 18′, 18″ . . . 18ⁿ. When one of the room options is selected the home station 12 returns to its home screen, an activity center being predominantly highlighted thereon. The activity centers 20, 20′, 20″ . . . 20ⁿ may include typical medical office activity centers. For example, in an oncology office, it may include: LAB, CHEMO, LPN, X-RAY, Rx, etc. The predominant highlighting may be, for example, a color change thereon. Alternative predominant highlighting may include, for example, flashing lights, and pixelation effects. Although numeral designations 18, 18′, 18″ . . . 18ⁿ have been shown to represent rooms, they could easily be configured to represent other locations such as beds in a room, for example, beds in an ICU ward. One of the principal benefits of this invention is the ability to be easily adapted to suit a particular need.

The processing system 14, i.e. server, may be any suitable conventional network related portable computer that runs on, for example, Windows 2000 or later operating system. The processing system 14 may be separate or integrated with the display 16.

At least one activity station 22, 22′, 22″ . . . 22ⁿ is associated with a respective activity center 20, 20′, 20″ . . . 20ⁿ. The activity stations 22, 22′, 22″ . . . 22ⁿ are operatively connected to the processing system 14. Each activity station 22 is configured to receive a message from the home station 12 indicating the selection of that activity station 22, thus generating an alert window at that activity station 22 providing directions to a room. Preferably, the selected activity station 22 is at least partially disabled to provide the person in that activity center with the incentive to respond. For example, the screen may be locked immediately or within a selected time. Use of a preselected time delay allows the person in the activity center with the ability to complete a short task at his/her computer screen before being compelled to answer the notification call. Partially disabling may involve use of various warnings of the impending lock. These may include, for example, an hourglass, time lapse indicator, screen dimming, etc. The activity stations 22 may be any suitable conventional network related portable computers that run on, for example, Windows 2000 or later operating system.

When the predominately highlighted activity center 22 on the home station 12 is deselected indicating that the message has been answered, the home screen thereon is returned to a state that does not show the predominant highlights. The deselection provides verification that the message has been answered. Typically, this deselection is made by the activity center staff member after completing the task.

The invention preferably includes a feature in which when the activity station generates an alert window providing directions to a room, it also generates an audible alert tone; and, wherein when the predominantly highlighted activity center is deselected from the home station touch screen, the alert tone stops.

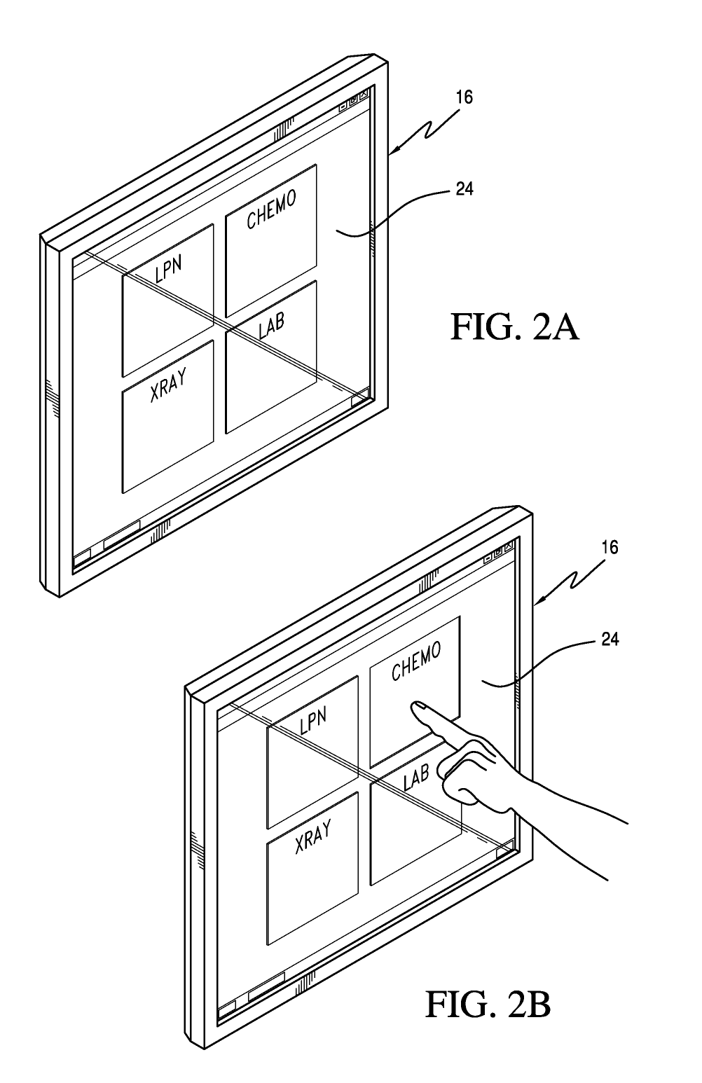

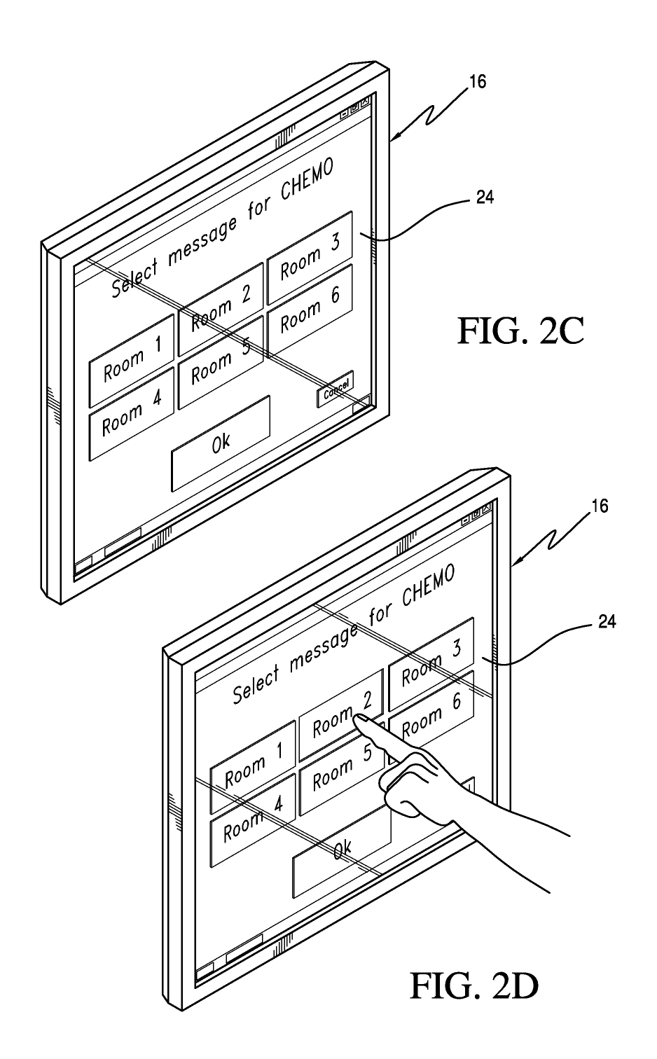

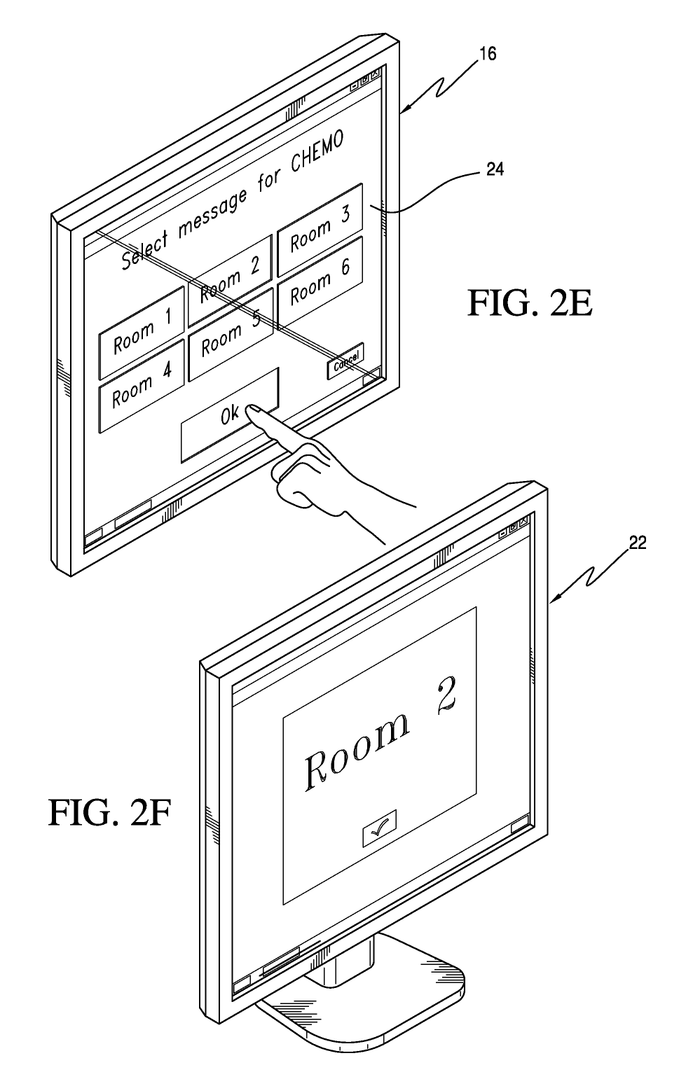

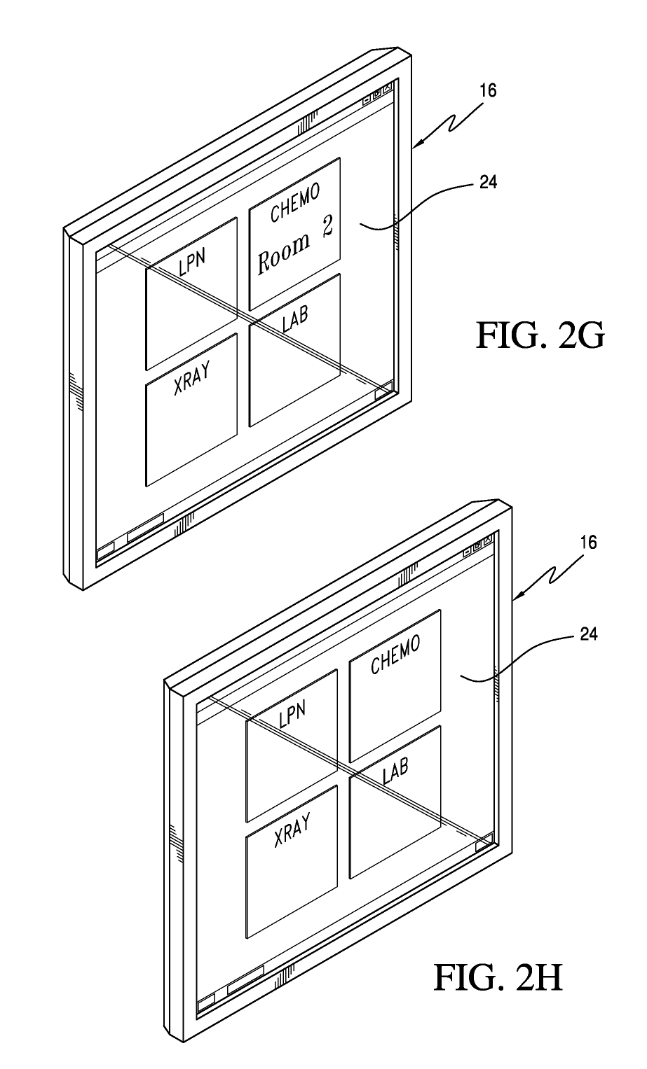

Referring now to FIGS. 2A-2H the process of the present invention is illustrated. As shown in FIG. 2A, in a first step of operation, a home station, including a wall mounted touch screen 16 displays a home screen 24, listing activity center selections LPN, CHEMO, XRAY, and LAB. As shown in FIG. 2B, the user at the home station selects an activity center; in this case, “CHEMO” on the home screen 24. As shown in FIG. 2C, the selection thereof generates a plurality of selectable patient room options.

FIGS. 2D and 2E illustrate the user selecting Room 2. The selection of a room option sends a message to the activity station 22 of the activity center 20. As shown in FIG. 2F, the activity station generates an alert window (i.e. “Room 2”) providing directions to the room.

As shown in FIG. 2G, the home station touch screen returns to its home screen, with the activity center (i.e. “CHEMO”) being predominantly highlighted thereon, in this case that activity center is highlighted as red. The selected room is also displayed (i.e. “Room 2”).

When the message has been answered the user at the home station deselects the predominately highlighted activity center on the home station touch screen. As shown in FIG. 2H, the home screen returns to a state that does not show the predominant highlights (i.e. it returns to the configuration of FIG. 2A). The deselection provides verification that the message has been answered. Any disablement of the activity station is reversed.

Although the invention has been described in a simple manner as having a number of activity center options, only one that has been chosen, it is understood that various activity centers and rooms can be chosen with the same home station.

Furthermore, the present invention can be implemented with a plurality of home stations. Referring now to FIG. 3 another embodiment of the present invention is illustrated, designated generally as 26. In this embodiment, a plurality of home stations 28, 28′ . . . 28ⁿ are utilized, each with a plurality of dedicated rooms 30, 30′ . . . 30ⁿ, 32, 32′ . . . 32ⁿ, 34, 34′ . . . 34ⁿ. In this example, the server (i.e. processing system) 36 is a separate unit from the home stations 28. As in the first embodiment, each of the various activity centers 38, 38′ . . . 38ⁿ are connected to the server 36.

Although the invention has been described in allowing the selection of an activity center first and a room second these inventive concepts also apply to the situation where the room is selected first and the activity center is selected second. Furthermore, the activity centers and rooms may be simultaneously presented on the same screen in the form of a grid or a matrix.

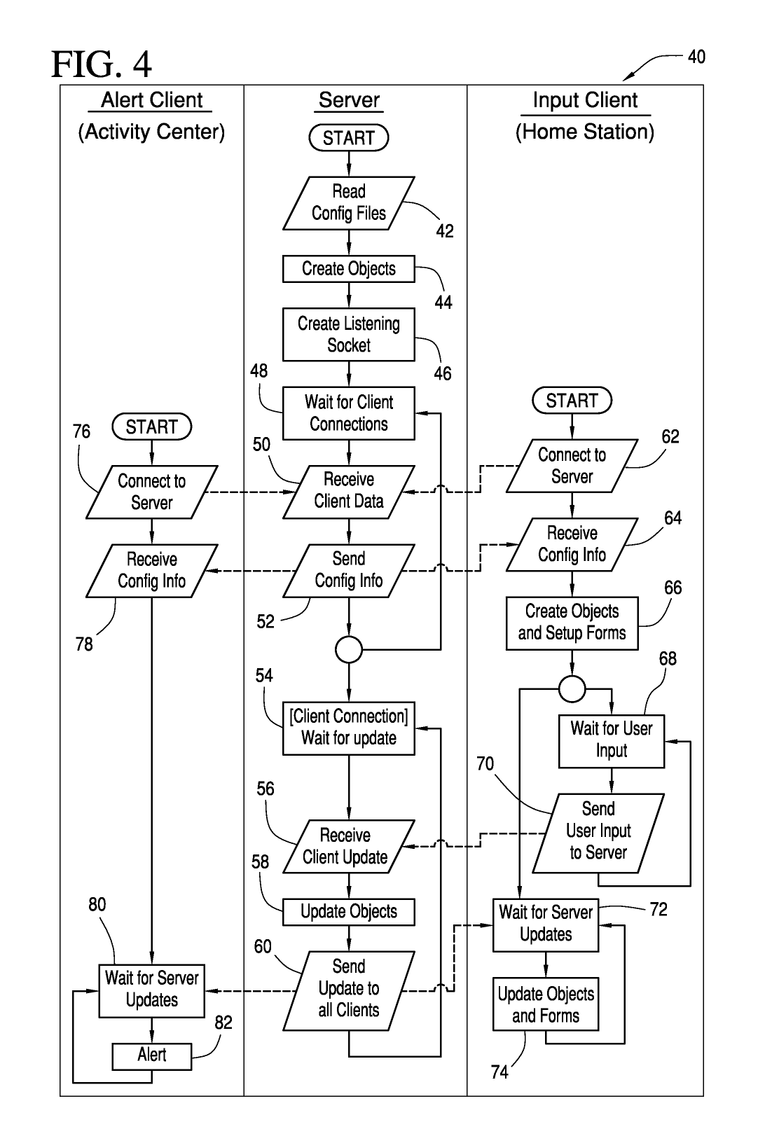

Referring now to FIG. 4, the software implementation of the embodiment of FIG. 3 is illustrated, designated generally as 40. The server 36 includes software configured to perform the process described below:

The server related software first reads a plurality of configuration files (process block 42) to configure the initial settings of the computer program. The configuration files describe the relationships between “objects”. For instance, a configuration file can list all of the “Option 1” choices (which could be activity stations), and then it will describe the valid “Option 2” choices for each of the “Option 1” choices (which could be a list of rooms pertinent to an activity station). They contain the ability to prioritize. As shown by process block 44, objects are then generated. At least a first set of the objects may represent a room in an office or, more generally, a location in a facility. An object might be, for example, a patient room, staff members room, activity center, etc. There may be different options for an object, i.e. a patient waiting in the room.

A listening socket is generated (process block 46). The listening socket is utilized to wait for connection attempts received from an alert client or an input client (process block 48), the alert client being from at least one activity station and the input client being from at least one home station.

The connection attempt is received from the alert client or input client, and client connection information is received (process block 50). The client connection information is used to update the objects. For example, identification data (e.g. identifying name, etc.) is received. The server sets up characteristics for the client.

The modified objects (i.e. configuration data) are sent to the appropriate home stations and under selected circumstances to appropriate activity stations (process block 52) while simultaneously waiting for the connection attempts from the alert client and the input client, and waiting for alert client or input client data updates (process block 54). One of the server's threads idles here and waits for network information to be received. The server can still be handling client requests and updates.

The server receives the alert client or input client data updates from a home station (process block 56). Alternatively updates can be received from an activity station. It is noted that although for the purposes of simplicity in explanation the flow chart shows certain functions sequentially certain of these processes may take place simultaneously, e.g. process blocks 48 and 54, as those skilled in this field would understand.

The received alert client or input client data updates are used to update the objects (process step 58). The state of the objects is modified.

The updated objects are then sent to the home stations; and, under selected circumstances to an activity center (process block 60). Data could also include disconnecting data. For example, if there are three home stations and one of them shuts down, it sends an update to the server to let it know that it is no longer connected. In this case, there might not be any updates sent to activity centers.

The wait is resumed for the connection attempts and for the client data updates.

Referring now to the input client software portion of FIG. 4, which is generally associated with a home station, the home station first connects to the server (process step 62). Configuration information is received from the server (process step 64). A plurality of objects are generated and forms configured from the received configuration information (process step 66). The forms provide the selectable activity center choices and selectable room options.

The home station then waits for user input information (process step 68). It then sends user input information to the server (process step 70) and resumes waiting for user input information.

It then simultaneously, waits for server update information and user input (process steps 68, 72). When it receives a server update, it updates the input forms it presents to the user and returns to waiting. When it receives user input it sends that information to the server. Finally, it resumes waiting for server update information.

Referring now to the alert client portion of FIG. 4, which is generally associated with an activity center, the activity center first connects to the server (process step 76). Configuration information is received from the server (process step 78).

The activity center then waits for server update information (process step 80). An alert is provided for the alert window in response to appropriate received server update information (process step 82). Finally, it resumes waiting for server update information.

Thus, in summary, when the home station connects to the server it downloads the configuration information which includes knowledge of whatever objects the server has created. Thus, there is knowledge of the types of options to present to the user. That knowledge is contained in the configuration file and is downloaded upon connection to the server. After downloading the configuration information the input client does two things: 1) it waits for updates from the server; and, 2) it waits for user input. It may be that the user is presented with a list of activity centers, rooms, or a matrix of activity centers and rooms. The input client then sends input to the server and the server reconciles it with its objects. Then, the server sends the updates to the input client and the alert client. A message is then sent to all of the clients to update their knowledge of the objects. The home stations may be configured to operate independently of each other or interconnected. Preferably, each input client retains a local copy of the objects and forms.

The software in the home station and activity centers may include the means for completely or partially disabling the software, as discussed above.

Other embodiments and configurations may be devised without departing from the spirit of the invention and the scope of the appended claims.

1. A medical activity notification process, comprising the steps of:
a) selecting an activity center on a home screen of a home station, said home screen of said home station having a plurality of selectable activity center choices, the selection thereof generating a plurality of selectable patient location options;
b) selecting one of said location options to send a message to an activity station of said activity center, said home station touch screen returning to its home screen, said activity center being predominantly highlighted thereon, said activity station generating an alert window providing directions to a location; and,
c) deselecting said predominately highlighted activity center on said home station touch screen, only when the message has been answered, thereby returning said home screen thereon to a state that does not show said predominant highlights, said deselection providing verification that said message has been answered.

2. The medical activity notification process of claim 1, wherein said selectable patient locations options comprise patient rooms.

3. The medical activity notification process of claim 1, further including the step of at least partially disabling said selected activity center when one of said location options is selected.

4. The medical activity notification process of claim 1, further including the step of at least partially disabling said selected activity center when one of said location options is selected, said partially disabling comprising the step of providing a warning prior to fully disabling.

5. The medical activity notification process of claim 1, wherein said selectable activity choices is selected from the group of medical activities comprising: LAB, CHEMO, LPN, X-RAY.

6. The medical activity notification process of claim 1, wherein when said activity station generates an alert window providing directions to a location, it also generates an audible alert tone; and, wherein when said predominantly highlighted activity center is deselected from said home station touch screen, said alert tone stops.

7. The medical activity notification process of claim 1, wherein said selected activity center is predominantly highlighted on said home screen by a color change thereon.

8. A medical activity notification process, comprising the steps of:
a) selecting a patient location option on a home screen of a home station, said home station having a plurality of patient location options, the selection thereof generating a plurality of selectable activity center choices;
b) selecting one of said activity center choices to send a message to a selected activity station of said selected activity center, said home station touch screen returning to its home screen, said activity center being predominantly highlighted thereon, said activity station generating an alert window providing directions to a location; and,
c) deselecting said predominately highlighted activity center on said home station touch screen, only when the message has been answered, thereby returning said home screen thereon to a state that does not show said predominant highlights, said deselection providing verification that said message has been answered.

9. The medical activity notification process of claim 8, wherein said selectable patient locations options comprise patient rooms.

10. The medical activity notification process of claim 8, further including the step of at least partially disabling said selected activity center when one of said activity center choices is selected.

11. The medical activity notification process of claim 8, further including the step of at least partially disabling said selected activity center when one of said activity center choices is selected, said partially disabling comprising the step of providing a warning prior to fully disabling.

12. An activity notification system for a facility having a plurality of locations and activity centers, comprising:
a) a home station including a processing system and a display operatively connected to said processing system, said display for generating a home screen having a plurality of selectable activity center choices, the selection thereof generating a plurality of selectable location options, wherein when one of said location options is selected said home station returns to its home screen, an activity center being predominantly highlighted thereon;
b) at least one activity station associated with a respective activity center, said at least one activity station being operatively connected to said processing system, said at least one activity station for receiving a message from said home station indicating the selection of said at least one activity station, thus generating an alert window at said at least one selected activity station providing directions to a location,
wherein, when said predominately highlighted activity center on said home station is deselected indicating that the message has been answered, said home screen thereon is returned to a state that does not show said predominant highlights, said deselection providing verification that said message has been answered.

13. The activity notification system of claim 12, wherein said selectable location options comprise patient rooms in a medical office.

14. The activity notification system of claim 12, wherein said facility comprises an office, said plurality of locations comprises a plurality of office locations, and said activity centers provide a plurality of office functions.

15. The activity notification system of claim 12, wherein said facility comprises a medical facility, said plurality of locations comprises a plurality of patient locations, and said activity centers provide a plurality of medical functions.

16. The activity notification system of claim 12, wherein said home station and said activity stations comprise touch screens.

17. The activity notification process of claim 12, wherein said home station includes means for partially disabling said selected activity center when one of said location options is selected.

18. The activity notification process of claim 12, wherein said home station includes means for partially disabling said selected activity center when one of said location options is selected, said selected activity center including means for providing a warning prior to fully disabling.

19. An activity notification system for a facility having a plurality of locations and activity centers, comprising:
a) a server configured to perform the process comprising the steps of:
i) reading a plurality of configuration files;
ii) generating a plurality of objects, at least a first set of said objects representing a location in a facility;
iii) generating a listening socket;
iv) utilizing said listening socket to wait for connection attempts received from an alert client or an input client, said alert client being from at least one activity station of an activity center and said input client being from at least one home station;
v) receiving said connection attempt from said alert client or input client, and receiving client connection information;
vi) using said client connection information to configure said objects;
vii) sending said modified objects to said at least one home station and under selected circumstances to said at least one activity station while simultaneously waiting for said connection attempts from said alert client and said input client, and waiting for alert client or input client data updates;
viii) receiving said alert client or input client data updates from a home station, or an activity station;
ix) utilizing said received alert client or input client data updates to update said plurality of objects; and,
x) sending said updated objects to said at least one home station and under selected circumstances to said at least one activity center; and,
xi) resuming wait for said connection attempts and for said client data updates;
b) at least one home station operatively connected to said server for displaying a home screen having a plurality of selectable activity center choices, the selection thereof generating a plurality of selectable location options, wherein when one of said location options is selected said home station returns to its home screen, an activity center being predominantly highlighted thereon; and,
c) at least one activity station associated with a respective activity center, said at least one activity station being operatively connected to said server, said at least one activity station for receiving a message from said home station indicating the selection of said at least one activity station, thus generating an alert window at said at least one selected activity station providing directions to a location,
wherein, when said predominately highlighted activity center on said home station touch screen is deselected indicating that the message has been answered, said home screen thereon is returned to a state that does not show said predominant highlights, said deselection providing verification that said message has been answered.

20. The activity notification system of claim 19, wherein said at least one home station is configured to perform the steps, comprising:
a) connecting to the server;
b) receiving said configuration information from said server;
c) generating a plurality of objects and configuring forms from said received configuration information, said forms providing said plurality of selectable activity center choices and said plurality of selectable location options;
d) waiting for user input information;
e) sending user input information to said server;
f) resuming waiting for said user input information;
g) simultaneously, waiting for server update information, updating said plurality of objects and said forms; and,
h) resuming waiting for server update information.

21. The activity notification system of claim 20, wherein said at least one activity station is configured to perform the steps, comprising:
a) connecting to the server;
b) receiving said configuration information from said server;
c) waiting for server update information;
d) providing said alert for said alert window in response to appropriate received server update information; and,
e) resuming waiting for said server update information.

22. The activity notification system of claim 19, wherein said selectable location options comprise patient rooms in a medical facility.

23. The activity notification system of claim 19, wherein said selectable location options comprise patient locations in a medical facility.

24. The activity notification system of claim 19, wherein said facility comprises an office, said plurality of locations comprises a plurality of office locations, and said activity centers provide a plurality of office functions.

25. The activity notification system of claim 19, wherein said facility comprises a medical facility, said plurality of locations comprises a plurality of patient locations, and said activity centers provide a plurality of medical functions.

26. The activity notification system of claim 19, wherein said home station and said activity stations comprise touch screens.

27. The activity notification process of claim 19, wherein said home station includes means for partially disabling said selected activity center when one of said location options is selected.

28. The activity notification process of claim 19, wherein said home station includes means for partially disabling said selected activity center when one of said location options is selected, said selected activity center including means for providing a warning prior to fully disabling.
